(19) United States
(12) Patent Application Publication
(10) Pub. No.: US 2026/0208310 A1
(43) Pub. Date: Jul. 23, 2026

(54) MACHINING SYSTEMS UTILIZING HIGH TEMPERATURE SUPERCRITICAL FLUIDS

(71) Applicant: Fusion Coolant Systems, Inc., Canton, MI (US)

(72) Inventors: Steven J. Skerlos, Ann Arbor, MI (US); Scott Jones, Royal Oak, MI (US)

(73) Assignee: Fusion Coolant Systems, Inc., Canton, MI (US)

(21) Appl. No.: 19/451,665

(22) Filed: Jan. 16, 2026

Related U.S. Application Data
(60) Provisional application No. 63/746,555, filed on Jan. 17, 2025.

(51) Int. Cl. B23Q 11/10

(52) U.S. Cl. CPC B23Q 11/1053

(57) ABSTRACT

Improvements in machining systems that utilize machining fluids including a supercritical fluid are described. Specifically, systems and methods related to the use of supercritical machining fluids heated to temperatures above their critical temperature are described.

### CROSS-REFERENCE TO RELATED APPLICATIONS

This application claims the benefit under 35 U.S.C. § 119(e) of U.S. Provisional Application Ser. No. 63/746,555, filed Jan. 17, 2025, the content of which is incorporated herein by reference in its entirety.

### FIELD

Disclosed embodiments are related to machining systems that utilize high temperature supercritical fluids.

### BACKGROUND

Machining tools, such as milling systems, lathes, computer numerical control (CNC) systems, robotic drills, and/or machining centers may employ machining fluids such as metalworking fluids to provide cooling and/or lubrication during a cutting or forming process. The machining fluid may be delivered to an interface between a cutting tool and a workpiece during a cutting or forming process. In some applications, the machining fluid may be delivered externally, such as by routing the machining fluid through a series of pipes and to one or more nozzles that direct the machining fluid toward the cutting interface. In other applications, the machining fluid may be routed internally to the interface, such as through a tool holder and/or through a cutting tool (e.g., through one or more channels formed in a cutting tool).

Conventional machining fluids may comprise mixtures including a cooling fluid (such as air, water, liquid carbon dioxide, or liquid nitrogen) to cool a cutting zone and a lubricant (such as oil, a minimum quantity lubrication (MQL) fluid, or synthetic fluids) to lubricate the cutting zone during a cutting process. In some instances, a machining fluid only including an oil, emulsion, or a synthetic fluid may be suitable. In some applications supercritical fluids, such as supercritical carbon dioxide (scCO₂) have been used as a portion of a machining fluid.

### SUMMARY

In one embodiment, a machining system utilizing a supercritical machining fluid includes: a machine tool; a first machining fluid supply constructed and arranged to deliver a first supercritical machining fluid to a cutting interface of the machine tool; and a heater configured to heat the first supercritical machining fluid to a predetermined temperature at least 20° C. greater than a critical temperature of the supercritical machining fluid.

In one embodiment, a method of machining a workpiece using a machining system utilizing a supercritical machining fluid includes: supplying a first supercritical machining fluid to a machining system; heating the first supercritical machining fluid to a predetermined temperature at least 20° C. greater than a critical temperature of the first supercritical machining fluid; and delivering the first supercritical machining fluid to a cutting interface between a machining tool and a workpiece.

In one embodiment, a system for providing a supercritical machining fluid includes: a first low temperature reservoir configured to contain a first supercritical machining fluid at a first temperature; a second high temperature reservoir configured to contain a second supercritical machining fluid at a second temperature greater than the first temperature; an outlet of the system; a first flow control device configured to control a first flow of the first supercritical machining fluid to the outlet; and a second flow control device configured to control a second flow of the second supercritical machining fluid to the outlet.

In one embodiment, a method of machining a workpiece using a machining system utilizing a supercritical machining fluid, the method includes: mixing a first flow of a first supercritical machining fluid at a first temperature with a second flow of a second supercritical machining fluid at a second temperature different from the first temperature to provide a combined flow of supercritical machining fluid at a third temperature between the first and second temperatures; and applying the combined flow of supercritical machining fluid to a cutting interface.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of a machining system utilizing a supercritical fluid, according to some embodiments;

FIG. 2 is a schematic representation of a centralized supercritical machining fluid distribution system, according to some embodiments;

FIG. 3 is a schematic representation of a centralized lubricant delivery system, according to some embodiments;

FIG. 4 is a schematic representation of a dual flow lubricant delivery system, according to some embodiments;

FIG. 5 is a flow chart depicting one possible method of use for a multi-flow lubricant delivery system, according to some embodiments; and

FIG. 6 is a graph depicting the impact of temperature on cutting.

### DETAILED DESCRIPTION

Aspects described herein relate to improvements in machining systems that utilize machining fluids comprising a supercritical fluid, such as supercritical carbon dioxide (scCO₂) or supercritical nitrogen. The inventors have appreciated that supercritical machining fluids may provide numerous benefits compared to conventional machining fluids, such as water-based machining fluids, oil-based machining fluids (e.g., neat oils), minimum quantity lubrication (MQL) fluids, or synthetic machining fluids. As used herein, a supercritical fluid refers to a fluid that is maintained above its critical point (i.e., at a temperature above the critical temperature and at a pressure above the critical pressure). For example, the critical temperature and pressure for carbon dioxide are 31.1° C. and 72.8 atm, respectively, which are readily achievable in industrial applications. Above the critical point, distinct liquid and gas phases do not exist; instead, supercritical fluids exhibit characteristics of both liquids and gases. For example, supercritical fluids may exhibit the flow and expansion behaviors of gasses while also being able to dissolve materials like a liquid. In machining applications, rapidly expanding supercritical machining fluids may provide better cooling and/or more efficient heat transfer, may provide for better mixing with lubricants or dissolution of lubricants, and/or allow for the use of smaller amounts of lubricants compared to conventional water-based machining fluids. Moreover, as described in more detail below, in some instances, rapidly expanding supercritical machining fluids comprising dissolved lubricants may precipitate small cooled droplets travelling at high speed, which may provide superior lubrication relative to conventional machining fluids.

Although some of the above-described properties of supercritical fluids have been recognized to provide a number of advantages in machining applications, the inventors have also recognized and appreciated that some aspects of the designs of conventional machining systems may not be well suited for use with supercritical fluids. In particular, the different properties and/or behaviors of supercritical fluids compared to conventional machining fluids may necessitate different approaches to the design of machining systems in order to accommodate the supercritical fluids. For example, the inventors have recognized advantages associated with systems that can deliver a fluid to a machining tool below its critical pressure and/or critical temperature, and subsequently raise the pressure and/or temperature of the fluid at the machining tool to generate a supercritical machining fluid. In some applications, a fluid may be stored above its critical pressure (e.g., in a storage tank associated with a machining tool and or in a centralized storage system that is configured to distribute the high pressure fluid to multiple machining tools), and the fluid may be heated to a temperature above its critical temperature at each machining tool when the supercritical machining fluid is required for a cutting process. In other applications, a supercritical machining fluid may be stored in one or more storage tanks specifically designed to store the supercritical machining fluid and maintain the fluid above the critical point during storage before it is needed during a cutting operation. As described in more detail below, in some embodiments, a supercritical fluid may be prepared and stored in a supercritical state and may be distributed to multiple machining tools through a centralized delivery system though embodiments in which individual machines include supercritical cutting fluid systems are also contemplated. Further, a supercritical machining fluid may either be heated to a desired machining temperature either upstream from, within, or downstream from the storage tank, including within an individual machine, as the disclosure is not limited to where or how a desired machining temperature of a supercritical machining fluid is provided.

The inventors have recognized that maintaining and/or delivering supercritical machining fluids at temperatures higher than the critical temperature yields marked improvements in machine tool life, energy consumption, and machining performance/efficiency. This may be especially true for certain types of materials that are sensitive to temperature changes for various machining processes. Accordingly, unlike typical processes using supercritical machining fluids which maintain a temperature of the machining fluid close to the critical temperature to avoid additional heating energy costs, in some embodiments, a machining process may be conducted using a supercritical machining fluid that is at least 20° C. greater than a critical temperature of the supercritical machining fluid or other appropriate temperature greater than the critical temperature as detailed below. This supercritical cutting fluid may exhibit the desired predetermined temperature at a point upstream from and proximate to a location where the supercritical cutting fluid expands. In some embodiments, this expansion may occur at an outlet or orifice formed in a tool, tool holder, separate nozzle, or other component used for delivering the supercritical machining fluid to an interface between a tool and a workpiece. The specific temperature to be applied during a machining process may be tailored to the cutting properties of the material being machined.

Without wishing to be bound by theory, it is believed that increased supercritical machining fluid temperature applied to a cutting process has several effects. First, higher temperatures reduce the density of supercritical machining fluids which further reduces flow during machining, which may have a synergistic impact in reducing heat removal caused by applying a supercritical machining fluid. In materials where a deformation mode may change and/or embrittlement may occur below a certain temperature this reduced heat removal may be beneficial. Additional, even though less supercritical machining fluid on a mass basis may be used, a machining process may not experience decreased lubricity as this may be independently controlled. For example, in one embodiment, the heat removal by a supercritical machining fluid may be controlled by modifying a nozzle size (e.g. nozzle diameters between about 50 μm and 500 μm) and independently controlling a delivery rate of a secondary machining fluid, such as oil, (e.g. from 0 mL per hour to 1.5 mL per hour or any other appropriate delivery rate). It is noted that lubricant droplets that exist during and after the expansion of the scCO2 may have a higher density than the expanding and/or expanded scCO2. As such, the lubricant droplets may provide additional heat removal capability above and beyond that of the scCO2. The heat removal capability of the lubricant droplets may be impacted by the temperature of the rapidly expanding scCO2 enveloping them. Lubricant selection, pressure, and flow (controlled by combination of pressure, density, and nozzle diameter) all have a significant impact on overall temperature characteristics of the process.

In one embodiment, a predetermined temperature of a supercritical machining fluid that is delivered to an interface between a tool and a material being machined may be greater than a critical temperature of the supercritical machining fluid by at least 20° C., 30° C., 40° C., 50° C., 60° C., or other appropriate temperature. The predetermined temperature of the supercritical machining fluid may also be greater than the critical temperature of the supercritical machining fluid by less than 100° C., 90° C., 80° C., 70° C., 6° C., and/or any other appropriate temperature. Combinations of the foregoing are contemplated including a predetermined temperature that is between or equal to 20° C. and 100° C. greater than a critical temperature of the supercritical machining fluid. Though embodiments in which different temperatures are used are also contemplated.

In the specific case of supercritical carbon dioxide, the predetermined temperature of the supercritical carbon dioxide delivered to the interface between the tool and the material being machined may be greater than or equal to 50° C., 55° C., 60° C., 70° C., 80° C., and/or any other appropriate temperature. Correspondingly, the predetermined temperature of the supercritical carbon dioxide may be less than or equal to 120° C., 110° C., 100° C., 90° C., 80° C., and/or any other appropriate temperature combinations of the foregoing are contemplated including a predetermined temperature that is between or equal to 50° C. and 120° C., 55° C. and 80° C., and/or any other appropriate combination. Of course, temperatures of supercritical carbon dioxide other than those noted above are also contemplated.

It should be understood that the currently disclosed machining processes using supercritical machining fluids heated to elevated temperatures may be used to improve machining processes with any material exhibiting temperature dependent machining properties. This may include, but is not limited to, materials such as: composite materials such as polymer composites including, for example, carbon fiber reinforced polymer composites; nickel based alloys with materials such as chromium, molybdenum, and/or cobalt including nickel based superalloys such as Inconel, René, Hastelloy, and Incoloy; cobalt chrome alloys (Co Cr alloys); and/or any other appropriate material. Due to the use of these materials in the medical, aerospace, and automotive industries, the disclosed machining processes may offer tangible benefits related to the speed and/or cost of machining components for these and other industries.

Several benefits have been recognized by the Inventors relative to the use of supercritical machining fluid at elevated temperatures. Specifically, longer tool life, faster achievable machining speeds for a given tool life, improved surface finish, improved dimensional control, and other machining process benefits have been observed for materials. However, it is noted that these benefits were not observed for materials such as titanium, at least some steels, and at least some aluminums.

The inventors have additionally recognized the challenges associated with using supercritical machining fluids to machine materials with certain thermal properties. For example, the relatively low temperatures of supercritical machining fluids may lead to work hardening and/or embrittlement. During work hardening, the workpiece being machined becomes less ductile and is strengthened via local plastic deformation, which makes the machining process more difficult and may, in some cases, decrease tool life and increase the risk of tool and/or workpiece damage. Additionally, the thermal transport properties of relatively small parts make them susceptible to overcooling during low temperature machining processes. This may lead to tolerancing issues and/or embrittlement. The thermal expansion properties of other materials, such as aluminum alloys, may cause them to expand or contract beyond an acceptable margin when they are machined above or below certain temperatures. This may lead to dimensional control issues. Other materials, including most metals, may also transition from a ductile to a brittle deformation modes below a threshold temperature. This transition may alter a materials machining properties such that an undesirable change to the cutting regime may occur.

In view of the above challenges, the inventors have recognized that it may be desirable to maintain specific thermal parameters (e.g., cooling/lubrication fluid temperature, tool temperature, part temperature, ambient interface temperature, etc.) throughout a machining process. These parameters may be determined based on the machining process being performed, the material composition of the workpiece being machined, the geometry (e.g., size, thickness, shape, etc.) of the workpiece being machined, or another factor. For example, sufficiently heating a supercritical machining fluid may result in a smaller drop in workpiece ductility, enabling more efficient machining. Thermal parameter control may be especially desirable when the workpiece comprises a relatively expensive material and/or when complex machining processes are being performed. For example, it may be especially desirable to maintain strict thermal parameters when machining components for the aerospace, automotive, and/or medical industries.

In light of the aforementioned challenges, the inventors recognize and appreciate the benefits of a system configured to easily control a temperature of a supercritical machining fluid. Specifically, in some embodiments, a system may mix a first supercritical machining fluid at a first temperature with a second supercritical machining fluid at a second temperature different from the first temperature to control a temperature of a combined machining fluid output from the system. Specifically, mixing the first and second supercritical fluids may provide a combined flow of supercritical machining fluid at a third temperature between the first and second temperatures. The final temperature of the combined flow can be easily controlled, or adjusted, by varying the ratio the first and the second supercritical machining fluids provided to form the combined flow. Once mixed, the combined flow at the third temperature may be applied to a cutting interface formed between a machine tool and a workpiece. In some embodiments, additional flows of supercritical fluids, non-supercritical fluids, and/or lubricants may be added to the combined flow.

A system configured to provide a combined supercritical machining fluid flow at a specific temperature may include a first low temperature reservoir, configured to maintain a first supercritical fluid at a first temperature, and a second high temperature reservoir, configured to maintain a second supercritical fluid at a second temperature greater than the first temperature. The system may further comprise a first flow control device operatively coupled to the high temperature reservoir and a second flow control device operatively coupled to the low temperature reservoir. The first and second flow control devices may be configured to control the flows of supercritical fluid leaving the first and the second temperature reservoirs as the supercritical fluids flow to a downstream outlet. Each of the temperature reservoirs may be configured to maintain the supercritical fluid at a pressure above its critical pressure and a temperature above its critical temperature such that the supercritical machining fluid remains in a supercritical state. In some instances, it may be desirable to include additional temperature reservoirs, flow control devices, and/or sensors such that additional flows of supercritical fluids and/or lubricants at specific temperatures can be provided.

The first low temperature reservoirs may be configured to heat the first supercritical fluid to a first temperature at or above the critical temperature of the first supercritical fluid. For example, in embodiments wherein the first supercritical fluid comprises supercritical carbon dioxide (scCO₂), the first temperature may at or above 31.1° C. Further, in some embodiments, the first thermal reservoir may be configured to heat the first supercritical fluid to approximately 35° C. In other embodiments, the first temperature may be greater than a critical temperature of the first supercritical machining fluid by at least 1° C., 2° C., 3° C., 4° C., 5° C., or other appropriate temperature. The first temperature of may also be greater than the critical temperature of the first supercritical machining fluid by less than 10° C., 9° C., 8° C., 7° C., 6° C., and/or any other appropriate temperature. Combinations of the foregoing are contemplated including a predetermined temperature that is between or equal to 1° C. and 10° C. However, the use of low temperature reservoirs with temperatures greater than those noted above are also contemplated as the disclosure is not so limited.

The second high temperature reservoir may be configured to heat the second supercritical fluid to a second temperature greater than the first temperature. For example, in some embodiments, second thermal reservoir may be configured to heat the second supercritical fluid to approximately 60° C. In other embodiments, the second temperature may be greater than the first temperature by at least 20° C., 30° C., 40° C., 50° C., 60° C., or other appropriate temperature. The second temperature may additionally be greater than the first temperature by less than 100° C., 90° C., 80° C., 70° C., 6° C., and/or any other appropriate temperature. Combinations of the foregoing ranges are contemplated including, for example, a second high temperature reservoir with a temperature that is between or equal to 20° C. and 100° C. greater than a temperature of a corresponding low temperature reservoir. However, it should be understood that temperatures of a high temperature reservoir both greater than and less than those noted above are contemplated as the disclosure is not limited in this fashion.

Without wishing to be bound by theory, it should be appreciated that the third temperature, achieved by combining a controlled flow of the first supercritical fluid at the first temperature with a controlled flow of the second supercritical fluid at the second temperature greater than the first temperate, may be any temperature between the first the second temperature. It should additionally be appreciated that by varying the ratio of the first supercritical fluid and the second supercritical fluid combined, a specifically commanded third temperature can be achieved. The third temperature may be chosen based on any number of factors including the material composition of the workpiece, the machining process being performed, the supercritical machining fluid being utilized, or another factor.

Additionally, in some embodiments, it may be desirable to mix a lubricant with the supercritical machining fluid flow before it is applied to the workpiece at the machining interface. The system may be configured such that the lubricant is added to the first supercritical machining fluid flow at the first temperature, the second supercritical machining fluid flow at the second temperature, or the combined mixture of supercritical machining fluids at the third temperature. Any of the lubricants discussed previously may be used as the disclosure is not limited in this respect. In some instances, the system may include a heated lubricant reservoir to heat the lubricant to a desired temperature. This temperature may either be greater than, less than, or between the first temperature and the second temperatures depending on the specific application. When mixed with the flow of supercritical fluids, the lubricant may impact the temperature of the supercritical fluids. Therefore, in some embodiments, a temperature of the lubricant may be controlled to be approximately that of the third temperature of the combined flow of supercritical machining fluid.

Additionally, the inventors have recognized and appreciated that systems utilizing a supercritical machining fluid at or above its critical temperature may require various components such as pumps, valves, seals, and/or other plumbing arrangements that are selected to be compatible with the supercritical machining fluid. For example, such components may be used in connection with systems to deliver a supercritical machining fluid to a machining tool (such as from a centralized distribution system), and/or from a supercritical fluid system associated with a particular machining tool. Moreover, the inventors have recognized and appreciated that many components within machining tools may not be compatible with supercritical fluids. For example, many seals used in conventional machining tools are formed from materials that are readily solubilized by supercritical machining fluids, which could lead to degradation and/or failure of the machining system. Accordingly, some aspects described herein relate to materials (e.g., for sealing arrangements) that are suitable for use with supercritical machining fluids, as described in more detail below.

While various embodiments described herein refer to supercritical machining fluids at or above their critical temperatures, it should be understood that the current disclosure is not limited to supercritical machining fluids that are maintained in their supercritical state throughout the entirety of a machining process. In particular, in some embodiments, the machining fluid may start in its supercritical state but may fall below the critical temperature and/or pressure during the machining process. The inventors have recognized and appreciated that many of the benefits described herein associated with the supercritical state may still be maintained if the machining fluid drops below the critical point. For example, in some applications, mixing a lubricant into a supercritical machining fluid may advantageously result in the lubricant dispersing into small cooled droplets upon the temperature and/or pressure of the supercritical machining fluid falling below their respective critical values such that the machining fluid loses its supercritical character. In particular, the inventors have appreciated that while the machining fluid is in the supercritical state, the lubricant may be fully dissolved in the matching fluid (i.e., the lubricant may be fully soluble in the supercritical fluid) such that such droplets may not exist while the machining fluid is in a supercritical state. Accordingly, in some embodiments, droplets of lubricant may be formed only upon the machining fluid transitioning out of the supercritical state.

In some instances, a supercritical machining fluid at or above its critical temperature may undergo rapid expansion as it is delivered into an open environment, such as when the supercritical fluid is delivered out of a nozzle or orifice of a cutting tool or tool holder at a cutting interface. The inventors have appreciated that this expansion of the supercritical fluid may aid in precipitating smaller and more uniformly sized droplets of lubricant compared to what is achievable with conventional machining fluids. Accordingly, in some applications, the supercritical machining fluids described herein may no longer be in a supercritical state at points in a machining process at which a part is being cut, cooled, and/or lubricated (e.g., within a spindle of a machining tool and/or at a cutting interface), but the use of the supercritical machining fluid may still provide multiple benefits compared to conventional machining fluids, particularly when the supercritical machining fluid is delivered as close to a cutting zone as practicable.

According to some aspects, systems described herein may provide for centralized preparation and storage of a supercritical fluid, and distribution of the supercritical machining fluid to one or more machining tools located within a machining facility (or other suitable environment). In one embodiment utilizing a supercritical machining fluid comprising scCO₂, the scCO₂ may be prepared and centrally stored, and the scCO₂ may be distributed to various machining tools within the machining facility as needed. For example, the scCO₂ may be prepared by pumping liquid CO₂ out of a bulk storage tank via a pressure booster (e.g., a pump such as a cryogenic pump, a gas blanket, or a gas booster). The pressure booster may raise the pressure of the CO₂ above the critical pressure. The high pressure CO₂ may then be directed through a heater such as an electric vaporizer that heats the CO₂ to a temperature greater than the critical temperature, thereby converting the CO₂ to its supercritical state. In some embodiments, the heater may raise the CO₂ to a temperature above its critical temperature. For example, in some embodiments, the supercritical cutting fluid may be heated to a predetermined temperature above the supercritical temperature associated with beneficial cutting properties for a material being machined as discussed previously above. In the case of scCO₂, a temperature of the supercritical cutting fluid may be greater than or equal to 50° C., and in some embodiments, less than or equal to 120° C. However, instances, in which the scCO₂, or other supercritical cutting fluid, is maintained at different temperatures are also contemplated. The scCO₂ is subsequently transferred to a high pressure, large volume storage vessel constructed and arranged to maintain the scCO₂ in the supercritical state. For example, the storage vessel may be suitably insulated to avoid heat loss (which could result in the temperature falling below the critical temperature). Moreover, in some embodiments, the storage vessel may include an active temperature control system including one or more heating elements, temperature sensors, and controllers configured to maintain the scCO₂ at the desired predetermined temperature above the critical temperature or any other appropriate temperature. The scCO₂ may be stored in the storage vessels until machining fluid is required within the machining facility (e.g., at one or more machining tools within the machining facility), at which time the scCO₂ may be drawn from the storage vessel and distributed to the machining facility as needed. In further embodiments, one or more secondary heaters may be included downstream of the storage vessels such that the scCO₂ may be heated further before being delivered to a cutting interface. In some instances, these one or more heaters may be located along the supply lines leading from the storage tanks to the machining facility or machining tool. In other instances, the one or more heaters may be located at each machining tool, for example at a housing of the machining tool, the spindle, the tool holder, the tool, or at a location proximate to any of the aforementioned components). As with above, these may be electric vaporizer heaters, or they may be thermoelectric Peltier heaters, electric resistance heaters, or any other suitable variety of heater and/or heat exchanger. In some instances, these secondary heaters may be used to maintain the supercritical cutting fluid at a desired temperature above the supercritical temperature and/or the secondary heaters may be used to heat the supercritical cutting fluid from a first lower temperature to a higher predetermined temperature which may be beneficial for a desired machining process and material.

In some embodiments, the storage vessel may comprise one or more large storage tanks, and/or a plurality of smaller storage tanks (e.g., cylinders) coupled to one another to form a large storage volume. Alternatively, or additionally, some storage vessels may be configured to store the machining fluid at a temperature and/or pressure below the critical temperature and/or pressure, respectively. In such embodiments, machining fluid stored in the storage vessel(s) may pass through one or more additional heaters and/or pressure boosters before being distributed to the machining tools to transform the machining fluid back into its supercritical state. In some embodiments, the one or more additional heaters may increase the temperature of the machining fluid to be greater than its critical temperature. Moreover, some systems may employ multiple storage vessels that may be configured to distribute the scCO₂ to a subset of the machining tools within a machining facility. In this manner, the multiple storage vessels may be arranged as distributed cells configured for distribution to certain portions of a machining facility or to a certain subset of machining tools within the machining facility.

The inventors have further recognized and appreciated numerous advantages associated with systems that provide centralized distribution of lubricant to multiple machining tools around a machining facility. In particular, conventional lubricant delivery arrangements typically utilize individual pumps associated with each machining tool to deliver a desired volumetric flow rate of lubricant to the machining tool. The inventors have appreciated that such arrangements can lead to significant costs. For instance, in some applications, a high pressure lubricant dosing pump may constitute a considerable portion of the total cost of a machining tool, and the individual pumps may lead to substantial maintenance and repair costs, especially in machining facilities including a large number of machining tools. Accordingly, some aspects described herein relate to centralized distribution systems that can deliver a required volumetric flow rate of lubricant to multiple machining tools from a central lubricant source. The inventors have appreciated that such arrangements may provide for simpler and cheaper lubricant delivery compared to conventional systems, and may provide for more robust systems requiring less maintenance and repair. Moreover, such centralized lubricant delivery arrangements may allow for substantially larger lubricant reservoirs compared to a reservoir that can be installed on an individual machine, which may allow for longer run times before the lubricant must be changed or refilled.

In one embodiment, a lubricant distribution system includes a high pressure lubricant pump that is constructed and arranged to distribute a metered network of lubricant throughout a machining facility, for example to deliver lubricant to up to fifty separate machining tools. Moreover, the volumetric flow rate of lubricant distributed to each machining tool may be independently adjustable to provide the required amount of lubricant for a particular machining process. In some embodiments, the systems described herein may be configured to deliver natural straight oils, emulsion concentrates, synthetic oil lubricants, and/or other lubricant formulations soluble in a supercritical fluid (e.g., scCO₂), as the current disclosure is not limited to any particular lubricant distributed by a lubricant distribution system. In some embodiments, at each machining tool in a machining facility, the MQL fluid (or other suitable lubricant) may be combined with a supercritical fluid and may also be delivered to the machining tools (e.g., from a centralized source, as discussed above, or from a supercritical fluid generation system associated with a particular machining tool) to form a supercritical machining fluid that is subsequently delivered to a cutting interface of the tool. While some embodiments of lubricant distribution systems are described in connection with systems utilizing supercritical machining fluids, it should be understood that the lubricant distribution systems also may be used in applications utilizing more conventional (i.e., non-supercritical) machining fluids.

In addition to the above, the inventors have recognized and appreciated that delivery of supercritical machining fluid at or above its critical temperature to a machining tool may present a number of challenges that are not present in conventional machining systems utilizing water-based machining fluids. In particular, in systems including rotary machining tools (e.g., CNC machines, lathes, mills, etc.), the machining fluid may be required to pass through a rotary union of the tool before reaching a cutting interface. Due to the high pressures and gas-like behavior associated with supercritical fluids, rotary unions which may be used in the systems described herein may need to be sealed more tightly compared to systems utilizing only conventional machining fluids. In some applications, rotary unions used with supercritical machining fluids may be designed with smaller diameters compared to systems using non-supercritical fluids. The inventors have also appreciated that a system configured to utilize a heated supercritical machining fluid may stress the joints of a rotary union to a greater extent than the joints would normally be stressed due to frictional heating. As such, it may be desirable for systems with rotary unions that utilize a heated supercritical fluid to include additional thermal management systems such as heat sinks, heat pipes, active cooling, and/or other appropriate methods of controlling a temperature applied to the rotary union.

Additionally, rotary unions in the systems described herein utilizing supercritical machining fluids at or above their critical temperatures may be designed to accommodate repeated pressurization and depressurization cycles associated with tool changes. For example, the rotary unions may comprise spring arrangements within a rotary joint configured to avoid closure of the rotary joint when the joint is pressurized by the pressure of the supercritical machining fluid. Some embodiments may comprise reclosing mechanisms for bearingless rotary joints that are configured to provide lubrication to the rotary joint during a tool change. In particular, in contrast to rotary joints utilizing conventional machining fluids, such as emulsions, that can adequately lubricate the seals during normal operation of the rotary joint, supercritical fluids may have difficulties adequately lubricating seals of rotary joints. The inventors have recognized that including a traditional oil, or other lubricant, in the supercritical fluid stream may alleviate this issue and provide more optimal lubrication and sealing at rotary joints. Accordingly, in some embodiments, the seal of a rotary joint may separate during a depressurization associated with a tool change, and the separation may allow a thin film of lubricant to be deposited onto the seal to provide lubrication. Moreover, as described in more detail below, in some embodiments, the materials used the various sealing components may be selected to provide compatibility with the supercritical machining fluid (e.g., to avoid undesirable solubility of the seal material in the supercritical fluid).

As noted above, while various embodiments are described herein that utilize centralized distribution of a supercritical machining fluid at or above its critical temperature, it should be understood that the current disclosure is not limited in this regard. For example, some embodiments may include individual systems for supplying a supercritical machining fluid to an associated machining tool. For instance, a supercritical machining fluid system may be coupled to a machining tool (such as a CNC machine), and the supercritical machining fluid system may deliver the machining fluid and/or lubricant to the tool as needed.

In certain embodiments, a temperature sensing arrangement may be used to monitor the temperature of the supercritical machining fluid as it is distributed to the machine tool and/or delivered to a cutting interface. For instance, a temperature of a supercritical cutting fluid may be monitored using either dedicated temperature sensors and/or existing temperature sensors included in a machining tool may be used. In particular, CNC machines often include thermocouples, resistance temperature detectors, or other suitable temperature sensors to monitor the temperature of the spindle (e.g., to monitor for overheating of the spindle). For example, temperature sensors may be located at any point of the distribution system from the one or more supply vessels, to the supply lines, to the machining tool or a component thereon (e.g., machine tool housing, spindle, tool holder, tool, etc.). Temperatures sensed by the one or more sensors may be communicated to an associated processor which may operate the previously discussed heaters to maintain the supercritical machining fluid in a desired temperature range. In some instances, this desired range may be above the critical temperature of the supercritical machining fluid as previously described. In some instances, the system may include a user interface such that an operator can alter the target temperature as desired.

As noted above, the inventors have recognized and appreciated that systems utilizing supercritical machining fluids at or above their critical temperatures may necessitate the selection of materials for various components of the machining system to provide compatibility with the supercritical fluid. For example, in some applications, it may be beneficial to utilize stainless steel tubing to route a supercritical machining fluid from a storage vessel (e.g., a centralized storage vessel as discussed above) to a rotary union (or other suitable connection) where the machining fluid is delivered to a cutting portion of machining tool (e.g., a spindle of a rotary machining tool). The dimensions of the stainless steel tubing may be selected based on the desired operating pressure ranges associated with the supercritical machining fluid delivery system. For example, in one embodiment, stainless steel tubing having an outer diameter between about 0.1 inches and about 0.5 inches (e.g., 0.25 inches), and a wall thickness between about 0.02 inches and about 0.05 inches (e.g., about 0.035 inches) may be suitable. However, it should be understood that that the current disclosure is not limited to any particular dimensions for the stainless steel tubing to deliver the supercritical machining fluid. Additionally, other materials for the tubing that may be suitable include, but are not limited to steel alloys, brass, titanium, Hastelloy, aluminum, and/or high pressure hoses.

Moreover, in some applications, some portions of a system (such as within a CNC system) may necessitate the use of flexible tubing to route the supercritical machining fluid to the cutting interface. In such systems, the flexible tubing may be selected based on compatibility with the supercritical machining fluid as well as based on the operating temperature ranges, which may be above the critical temperature of the supercritical machining fluid, and pressure ranges. For example, in one embodiment utilizing a scCO₂-based machining fluid, suitable tubing materials include, but are not limited to, Parker Paraflex 520N-4 hydraulic hoses, PTFE lined braided stainless steel hoses such as Swagelok B-Series, convoluted stainless steel core hoses such as Swaglok FX Series, polyamide core hoses such as Fluke DH400, and nylon core hoses such as Swagelok 7R series.

In addition to the above, the various seals, O-rings, and joints used in the systems described herein that may come into contact with the supercritical machining fluid at or above its critical temperature may be selected based on the operating temperature and pressure ranges associated with the supercritical fluid as well as to provide compatibility with the supercritical fluid. For example, operating pressures may be between about 100 and 140 bar, and in some instances, up to about 200 bar, 300 bar, 400 bar or more, and operating temperatures may be between about 20° C. and about 120° C. or higher. In some embodiments, suitable materials for seals and O-rings that can operate in these pressure and temperature ranges and also provide compatibility with supercritical fluids such as scCO₂ include, but are not limited to, Kalrez 0090, hard durometer Viton, Viton encapsulated with fluorinated ethylene propylene (FEP), and polytetrafluoroethylene (PTFE). In some applications, it may be beneficial to select highest durometer available of a seal or O-ring formed from a suitable material. Moreover, joints that may be suitable for connecting various portions of the systems described herein include, but are not limited to, hydraulic joints such as National Pipe Thread (NPT), British Standard Pipe (BSP and/or BSPP), Joint Industrial Council (JIC), and/or other compression fittings rated to greater than or equal to 200 bar.

Moreover, while some embodiments described herein include a lubricant (such as one or more oils, a metalworking fluid emulsion concentrate, and/or an MQL fluid) mixed with a supercritical fluid to form a supercritical machining fluid, it should be understood that the current disclosure is not limited to machining fluids including a lubricant. For example, in some applications, the supercritical fluid alone may provide sufficient cooling and/or lubrication during a cutting process. In other applications, a coolant fluid (e.g., water) may be added to a supercritical machining fluid to add mass and/or additional heat transfer capability to the machining fluid. Accordingly, it should be understood that a supercritical machining fluid may refer to a supercritical fluid with, or without, additional components such as lubricants or coolants. Additionally, embodiments in which a second supercritical machining fluid is mixed with a first supercritical machining fluid are also contemplated.

For the sake of clarity the embodiments herein are primarily described as using scCO₂. However, the current disclosure is not limited to only being used with scCO₂. Instead, the various embodiments described herein may be used with any appropriate super critical machining fluid including, for example, supercritical nitrogen, mixtures supercritical nitrogen and supercritical carbon dioxide as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

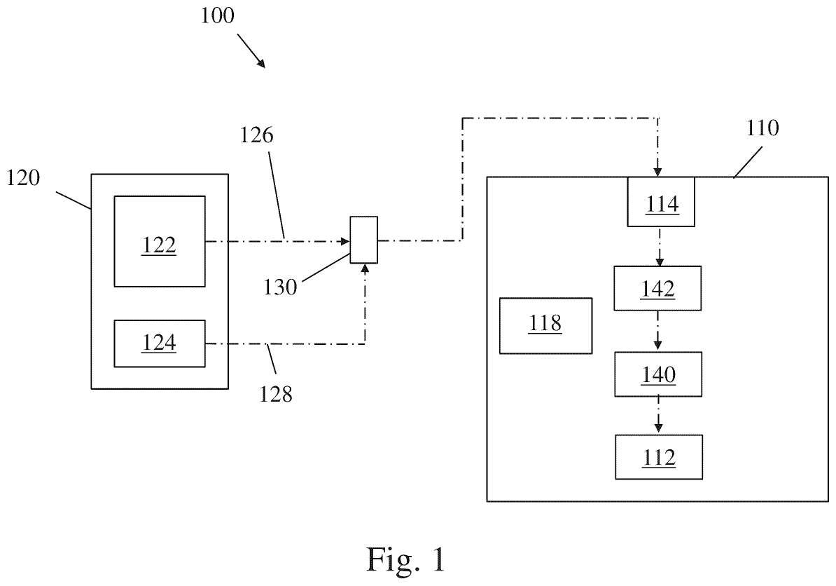

FIG. 1 is a schematic representation of a machining system 100 utilizing a supercritical machining fluid. The system 100 includes a machining tool 110 (e.g., a CNC machine, a lathe, and/or turret lathe) including a cutting interface 112 where a cutting or forming operation may be performed. For example, the cutting interface may include a rotating spindle to which a cutting tool may be attached. Some systems, such as turret lathe systems, may include multiple cutting tools that may be selected based on a particular desired cutting operation. The machining tool 110 further includes a coupling 114, such as a rotary union, that couples the cutting interface to a machining fluid system 120. Additionally, machining tool 100 may include a heater 140 in line with the flow of supercritical machining fluid. The heater may be an electric vaporizer, thermoelectric Peltier heater, electric resistance heater, or any other suitable variety of heater and/or heat exchanger. This heater may be used to adjust the temperature of a machining fluid before it is delivered to the cutting interface 112. In instances where a supercritical machining fluid is used, such as those described above, the heater 140 may either heat the supercritical machining fluid to a desired temperature above its critical temperature and/or maintain the supercritical machining fluid at a desired temperature, For example, in systems utilizing scCO₂, the heater may heat the scCO₂ to a temperature between 50° C. and 120° C. As depicted in FIG. 1, heater 140 is located within the machining tool 110, although it should be appreciated that a heater may be located at any desired location within a lubrication system and/or machining tool as the disclosure is not limited to where or how the supercritical machining fluid is heated.

The machining fluid system 120 includes a machining fluid supply 122 and a lubricant supply 124. In some embodiments, the machining fluid supply may be configured to deliver a supercritical machining fluid (e.g., scCO₂) to the machining tool 110, however, embodiments configured for conventional machining fluids (i.e., non-supercritical fluids) also may be suitable. The machining fluid and lubricant are delivered to the coupling 114 via supply lines 126 and 128, respectively. Moreover, the machining tool 110 includes a controller 118 which may include a processor and associated non-transitory processor readable storage medium storing processor executable instructions that when executed control various aspects of the operation of the machining tool, such as the operation of the cutting tool during a cutting operation. The controller 118 is also operatively coupled to a valve arrangement 130 such that the controller may control the delivery of supercritical fluid and/or lubricant to the machining tool 110. In embodiments where it is desirable to adjust the temperature of a supercritical machining fluid before it is delivered to the cutting interface 112, the controller 118 may be operatively connected to a heater 140 and temperature sensor 142 such that a processor of the controller is configured to control a temperature of the delivered supercritical machining fluid. For example, the temperature sensor 142 may sense a temperature of the supercritical machining fluid that is then output to the processor of the controller which may then control the heater using a feedback loop to control a temperature of the supercritical machining fluid to be within a desired operating range. While the heater has been depicted as being located within the machining tool upstream from the cutting interface where the supercritical machining fluid expands, it should be understood that one or more heaters used to control the temperature of a supercritical machining fluid provided to a system may be located at any point either within or between a source of supercritical machining fluid and machining tool as the disclosure is not limited to where the one or more heaters are located.

Depending on the particular embodiment, the machining fluid supply 122 may be a standalone system that may be coupled to an individual cutting tool to deliver the supercritical machining fluid to the cutting interface 112 during the cutting operation, or it may be a centralized distribution system configured to deliver machining fluid to multiple cutting tools within a machining or cutting center. Similarly, the lubricant supply 124 may be a standalone system coupled to an individual machining tool, or the lubricant supply may be a centralized lubricant distribution system configured to deliver lubricant to multiple machining tools within a machining facility.

Moreover, it should be understood that the current disclosure is not limited to any particular type of machining tool 110. For example, the tool could include a CNC machine, a lathe, a turret lathe, a mill, a robotic drill, or any other suitable machining system.

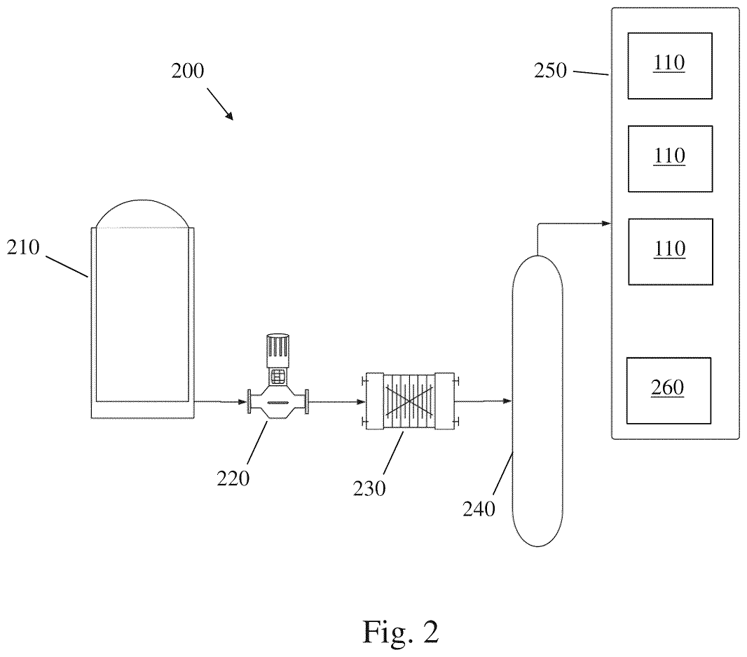

Referring now to FIG. 2, one embodiment of a system 200 for preparing and distributing a scCO₂-based supercritical machining fluid is described in more detail. The system includes a storage tank 210 configured to contain liquid CO2. For example the storage tank 210 may be a vacuum jacketed, vertical tank in which the liquid CO₂ is maintained at a pressure of approximately 20 bar and a temperature of about −18° C. Liquid CO₂ is supplied from the storage tank 210 to one or more pumps 220 such as cryogenic pumps. In some embodiments, the liquid CO₂ may be drawn from the bottom of storage tank 210. In this manner, the system may utilize a head pressure of the liquid column in the storage tank to maintain a minimum net positive suction head (NPSH) at the suction port of the pump 220. The pump is configured to compress the liquid CO₂ and increase the pressure of the liquid CO₂ to a pressure above the critical pressure, e.g., up to about 200 bar. The high-pressure liquid CO₂ is then directed through a heater 230, such as an electric vaporizer or other appropriate heater, that heats the CO₂ to a temperature above its critical temperature (i.e., greater than 31° C.). In some embodiments, the heater 230 may be configured to heat the high-pressure liquid CO₂ to a temperature above its critical temperature as previously described to aid in particular machining processes. For example, the heater may heat the scCO₂ to a temperature between 50° C. and 120° C. or any other appropriate temperature range. However, instances in which the scCO₂ is not significantly overheated at this first stage are also contemplated. By heating the fluid to above its critical temperature, the high-pressure liquid CO₂ is converted to its supercritical state (scCO₂). The scCO₂ is then transferred to a high pressure, large volume storage vessel 240, which may include one or more heating elements, insulation, and closed looped controls configured to maintain the temperature above the critical temperature. In some embodiments, these one or more heating elements may be configured to either maintain or heat the scCO₂ to a temperature above its critical temperature as described above. For instance, scCO₂ may either be fed into the storage vessel at a desired temperature greater than the supercritical temperature or the heaters may further heat the scCO₂ to a higher temperature for a desired cutting process. When needed for machining operations, the scCO₂ is subsequently distributed from the storage vessel 240 and into a machining facility 250 including a plurality of machining tools 110, and the scCO₂ may be routed to the individual machining tools. In some embodiments, some or each of the plurality of machining tools 110 may include an additional heater for either maintaining the scCO₂ at a desired elevated temperature relative to the supercritical temperature or for heating the scCO₂ to a desired temperature above its critical point.

While a single storage tank 210 is shown in FIG. 2, it should be understood that other arrangements may be suitable. For example, as noted above, some embodiments may employ a plurality of smaller storage tanks (e.g., cylinders) coupled to one another to form a single larger storage volume. In some embodiments, such storage tanks may be located within the machining facility 250. Alternatively or additionally, some embodiments may employ multiple storage tanks and/or pluralities of smaller storage tanks arranged to form distribution cells that are configured to distribute the scCO₂ to different portions of a machining facility and/or to different subsets of machining tools within a machining facility.

Moreover, in some embodiments, the system 200 may further include a centralized lubricant distribution system 260. As discussed above, the lubricant distribution system may be constructed and arranged to distribute lubricant (e.g., MQL lubricant) to multiple machining tools 110, where the lubricant may be mixed with the scCO₂ machining fluid. Alternatively, each machining tool may be provided with a separate lubricant source that is coupled to a supply of scCO₂ from the system 200.

In the depicted embodiment, the scCO₂ is prepared and stored outside of the machining facility 250 and distributed to machining tools 110 located within the machining facility 250. However, embodiments in which some or all of the components of the system 200 are located within the machining facility 250 are also contemplated. For example, in one embodiment, the storage tank 210 may be located outside of the machining facility, while the pump 220, heater 230, and storage vessel 240 may be located within the machining facility. Moreover, while three machining tools 110 are depicted in the figure, it should be understood that the centralized distribution systems described herein may be used with any suitable number of machining tools.

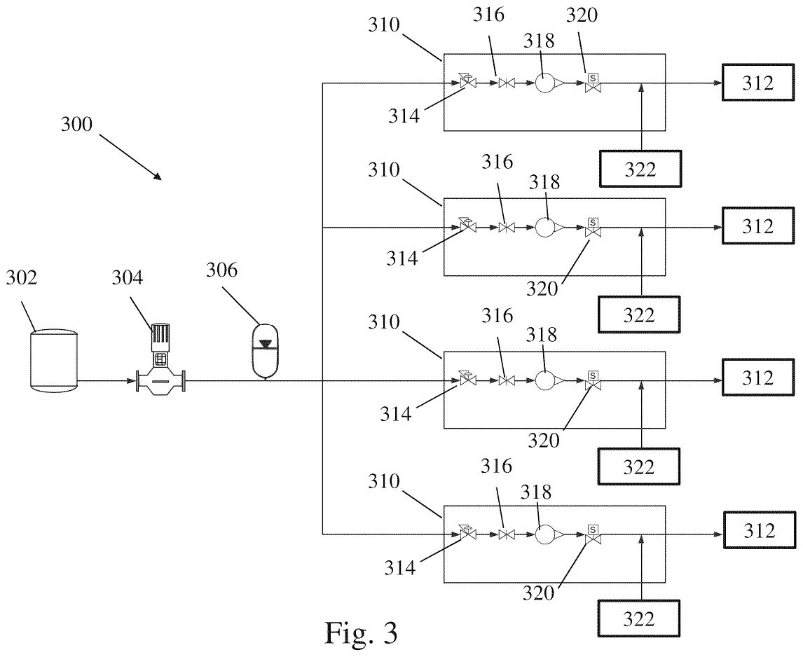

Referring now to FIG. 3, one embodiment of a centralized lubrication delivery system 300 is described in more detail. The system 300 includes a centralized lubricant reservoir 302, a pump 304 (e.g., a hydraulic pump), and a storage vessel 306 (e.g., a hydraulic accumulator), from which lubricant may be distributed to a plurality of lubricant modules 310. Each lubricant module may be coupled to one or more machining tools 312 and may be configured to provide a desired flow rate of lubricant to the attached machining tool(s). In particular, each lubricant module 310 may include a pressure reducing regulator 314, a needle valve 316, an optional flow meter 318, and a solenoid valve 320. The regulator and valves may be configured to provide the desired flow rate and/or pressure of the lubricant for a particular machining process at a machining tool 312. Moreover, each lubricant module 310 may include a machining fluid supply 322 through which a machining fluid, such as a supercritical machining fluid, may flow to mix with the lubricant before being delivered to the machining tool 312. While a lubricant distribution system including four lubricant modules is shown in FIG. 3, it should be understood that the current disclosure is not limited to any particular number of lubricant modules and/or machining tools to which a lubrication delivery system delivers lubricant.

While the lubricant modules 310 are depicted as being positioned outside of the associated machining tools 312 in FIG. 3, it should be appreciated that other configurations may be suitable. For example, in some embodiments, the lubricant modules may be configured as an internal component of a machining tool (e.g., a lubricant module may be positioned within a housing of a machining tool) or may be directly attached to a machining. Similarly, it should be appreciated that one or more additional components and/or systems described above, such as components of a machining fluid distribution system or one or more heaters configured to maintain a supercritical machine fluid above its critical temperature, may be included as a component of a machining tool, be directly attached to and/or positioned within a housing of the machining tool, and/or positioned at any other desired location as the disclosure is not limited to where these various components are located.

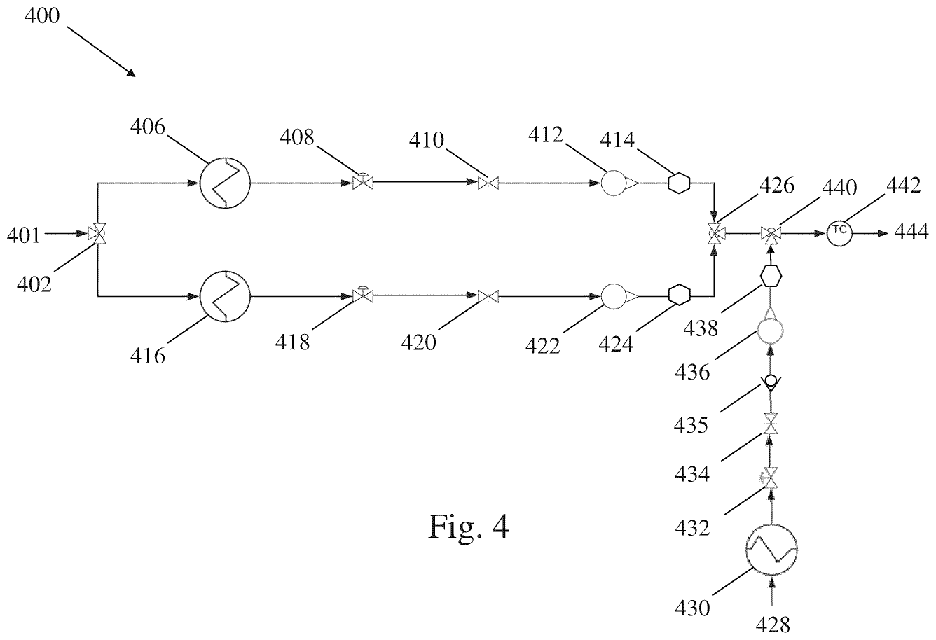

Referring now to FIG. 4, one embodiment of a dual flow system 400 configured to provide a flow of supercritical machining fluid to a machining interface at a specific temperature is described in more detail. The system 400 includes one or more initially heated fluid sources 401 which in the depicted embodiment provide a flow of fluid that splits into multiple flow paths that flow into two or more reservoirs at upstream junction 402. The first flow path includes a first low temperature reservoir 406 as well as a pressure regulator 408, a control valve 410, a mass flow sensor 412, and optionally one or more additional sensors 414 located downstream from the first low temperature reservoir. While not included in the depicted embodiment, it should be appreciated that one or both of the first and second flow paths may include a check valve configured to prevent back flow of the supercritical machining fluid. The second flow path includes a second high temperature reservoir 416 as well as a second pressure regulator 418, a second control valve 420, a second mass flow sensor 422, and optionally one or more additional sensors 424 located downstream from the second high temperature reservoir. The two flow paths are recombined at downstream junction 426. The dual flow system embodiment shown in FIG. 4 may also include an optional lubricant flow path. The lubricant flow path includes a flow of lubricant 428 that flows into a third lubricant reservoir 430. Alternatively, the lubricant may simply flow out of a lubricant reservoir without a flow into the reservoir depending on the embodiment. In either case, the lubricant flow path may also include: a pressure regulator 432; a control valve 434; a check valve 435 configured to prevent the backflow of the lubricant in the upstream direction towards the lubricant reservoir; a mass flow sensor 436; and optionally one or more additional sensors 438 disposed downstream from the lubricant reservoir. The lubricant flow path may flow into the flow of supercritical machining fluids at any desired point along the first and/or second flow paths. However, in the depicted embodiment, the lubricant flow path is combined with the combined supercritical flows at a junction 440 located downstream from junction 426 where the flows of the first and second supercritical machining fluids are combined. The system may also include a final temperature sensor 442 disposed downstream from the junction 440 and upstream from an outlet 444 of the system. Depending on the particular application, appropriate heaters may be included in any of the reservoirs to provide a desired temperature of the materials contained therein.

A flow rate of the lubricant from the lubricant reservoir to the primary flow path including the supercritical machining fluid may be greater than or equal to 0.1 mL per minute, 0.2 mL per minute, 0.25 mL per minute, 0.5 mL per minute, 1 mL per minute, and/or any other appropriate range. Correspondingly, the flow rate of lubricant may be less than or equal to 2.0 mL per minute, 1 mL per minute, 0.5 mL per minute, and/or any other appropriate flow rate. Combinations of the foregoing are contemplated including, for example, a flow rate of the lubricant that is between or equal to 0.1 mL per minute and 2.0 mL per minute, between or equal to 0.25 mL per minute and 1.0 mL per minute, and/or any other appropriate flow rate including flow rates both greater than and less than those noted above.

During operation the fluid from the initially heated fluid source 401 may flow into the system above its critical temperature and/or pressure such that the initially heated fluid 401 flows into the system in a supercritical state or a state that is close to supercritical. After flowing through the upstream junction 402, the fluid flows into two or more flow paths. A first flow path brings a first flow of fluid to the first low temperature reservoir 406 where it may be heated and/or pressurized to a desired temperature and pressure to provide a supercritical machining fluid at the desired first temperature. Alternatively, embodiments in which the fluid flows into the low temperature reservoir at the desired temperature and/or pressure are also contemplated. Correspondingly, a second flow of the fluid flows along the second flow path into the second high temperature reservoir 416. Similar to the low temperature reservoir, the second temperature reservoir may be configured to either to heat and/or maintain the fluid in a supercritical state at the desired greater second temperature. In some instances, the pressure regulators 408 and 418 located downstream from the associated reservoirs may be configured to provide a desired pressure of the first and second flows of supercritical machining fluid. In some embodiments, the pressures of the first and second flows of supercritical machining fluids may be the same. Appropriate pressure regulators may include, but are not limited to, back pressure regulators, vacuum pressure regulators, differential pressure regulators, pressure-reducing regulators, or any other appropriate variety of pressure regulator. Additionally, the pressure regulators can either be manually adjustable or controlled electronically using a closed loop feedback system.

As depicted in figure, each flow path may additionally include a flow control device such as the depicted control valves 410 and 420, located downstream from the associated reservoir. Systems may also include a mass flow sensor 412 and 422 downstream from each of the temperature reservoirs 406 and 416. The flow control devices and sensors may be operatively coupled with an associated processor to control the flow of supercritical machining fluids through the system. During operation, the processor may monitor the flow rate of supercritical machining fluid through each flow path and may correspondingly control the flow rate of supercritical machining fluid through each flow path using the flow control device associated with each corresponding reservoir. While needle valves have been depicted in the figure, it should be appreciated that any appropriate type of flow control device may be used to control a flow of supercritical machining fluid from each reservoir. Appropriate types of flow control devices may include, but are not limited to, needle valves, gate valves, globe vales, electronically controlled ball valves, and/or any other appropriate type of flow control device capable of controlling a flow rate from the reservoirs.

In some embodiments, each flow path from the high and low temperature reservoirs 406 and 416 may additionally include a temperature sensor, see additional sensors 414 and 424, configured to monitor the temperature of the supercritical fluid flowing from each reservoir to the downstream junction 426. However, other additional sensors that may be included along each supercritical flow path downstream of the temperature reservoirs 406 and 416 may include additional mass flow sensors, temperature sensors, pressure sensors, etc. In the embodiment of FIG. 4, these are shown to be located immediately prior to downstream junction 426, however it should be appreciated that any suitable sensor arrangement may be installed at any point throughout the system as the disclosure is not limited in this fashion.

At downstream junction 426, the two or more flows of supercritical fluid are recombined such that a single combined flow of supercritical fluid at a temperature between that of the first low temperature reservoir 406 and the second high temperature reservoir 416 is provided. Due to the inclusion of separately controlled flow control devices 410 and 420, the relative amounts of supercritical machining fluid flowing into downstream junction 426 from each of the reservoirs may be easily controlled. In this way, it is possible to control the temperature of the combined flow of supercritical fluid. For example, flowing a relatively lower proportion of supercritical machining fluid from the first low temperature reservoir 406 and a relatively higher proportion of supercritical machining fluid from the second high temperature reservoir 416 into downstream junction 426 will result in a combined flow of supercritical fluid at a temperature greater than if a relatively higher proportion of supercritical fluid from the first low temperature reservoir 406 and a relatively lower proportion of supercritical fluid from the second high temperature reservoir 416 were flowed into downstream junction 426. Thus, controlling the temperatures and amounts of supercritical machining fluids that are combined at junction 426 from each of the two or more flow paths may enable the delivery of a supercritical machining fluid at a predetermined, and in some instances variable, temperature to a cutting interface.

As noted above, the system may also include a lubrication flow path, which in some instances may include a lubricant that is heated to a desired temperature in the third lubricant reservoir 430. Due to the lubricant being in a liquid (i.e. non-supercritical state), the mass and associated thermal capacity of the lubricant may be non-trivial relative to the supercritical machining fluids which may go through an expansion process when delivered to a cutting interface. Thus, in some instances, the lubricant may be heated. In some embodiments, the lubricant may be heated to have the same temperature as the combined supercritical fluid flow. However, instances in which the temperature of the lubricant is either greater than or less than that of the combined flow of supercritical machining fluid are also contemplated. Similar to the other flows, the lubricant pressure regulator 432 may regulate the pressure of the lubricant flow path such that it is equal to the pressure of the combined supercritical fluid flow. However, instances in which a displacement pump, or similar device, is used to dispense a controlled amount of the lubricant without the use of a pressure regulator are also contemplated. In such an embodiment, the system may control the flow of the lubricant volumetrically. Thus, the essentially incompressible nature of the lubricant may enable the pressure of the liquid lubricant to naturally equalize with the flow of supercritical machining fluid as it flows into and mixes with the flow of supercritical machining fluid. Similar to the prior embodiments, a lubricant may be provided in a liquid (i.e. non-supercritical) state and may correspond to any appropriate type of lubricant as previously noted. While the embodiment of FIG. 4 includes a lubricant reservoir, embodiments that do not include a separate lubricant reservoir are also contemplated.

After the combined supercritical fluid flow is optionally mixed with a lubricant, a temperature of the combined supercritical fluid flow may be measured by a final temperature sensor 442 that is located downstream from the junctions where the supercritical machining fluids and optional lubricant are mixed. This final temperature may be used by a control loop which varies the relative flow rates of the first and the second supercritical machining fluids by adjusting the first and second control valves 410 and 420, or other flow control device. Finally, the combined supercritical machining fluid flow exits the system through outlet 444. The outlet 444 may be configured to direct the combined supercritical flow, and any additional lubricants or other fluids that may have been added, to a desired location such as a central distribution point of a supercritical machining fluid, a cutting interface of an individual machine system, and/or any other appropriate location and/or application as described above.

While not depicted, the system may also include one or more additional sensors operatively coupled to the system. For example, the system may additionally comprise a temperature sensor configured to monitor the workpiece temperature as it is being machined. As described above, it may be desirable to maintain a workpiece at a specific temperature to prevent overcooling, dimensional issues, embrittlement, etc. A sensor configured to monitor the workpiece temperature may be operatively connected to one or more processors, which may be configured to adjust the first and second control valves 410 and 420, to change the temperature of the combined flow of supercritical machining fluid provided to the cutting interface to control a temperature of the workpiece to be within a desired range of operating temperatures.

While not depicted, the system may also include one or more processors operatively coupled to the various pressure regulators, flow control devices, heaters, sensors, and other components to control operation of the system. The one or more processors may be operatively coupled to a non-transitory processor readable memory that may include processor executable instructions that when executed perform the methods described herein. The one or more processors may control operation of the disclosed systems using any appropriate control methodology including both open and closed loop control methods. Additionally, embodiments in which the various temperature setpoints, pressure regulators, and flow rates of the supercritical machining fluids and lubricants are manually controlled are also contemplated as the disclosure is not limited in this fashion.

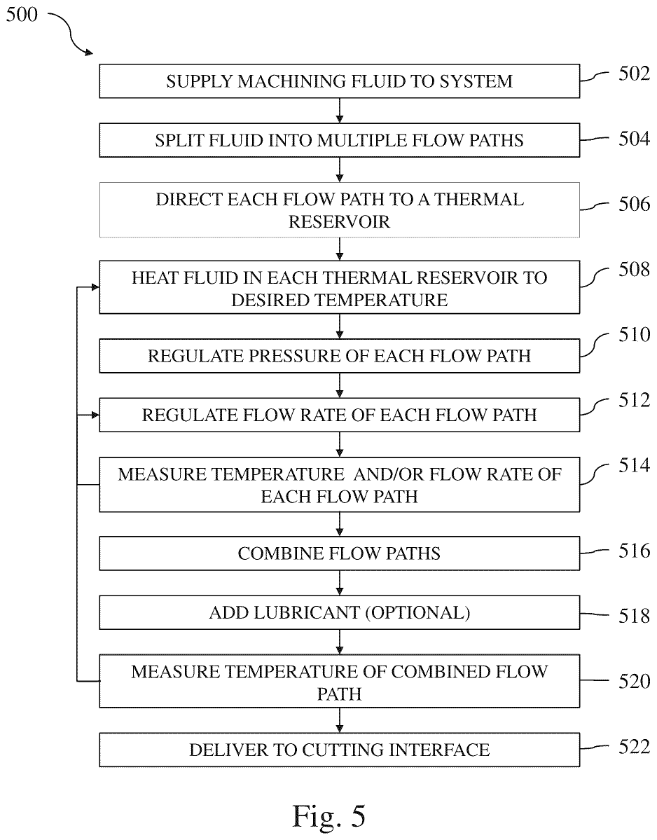

FIG. 5 shows a method 500 of using a multi-channel flow system such as the one depicted schematically in FIG. 4. Initially, a machining fluid is supplied to the system at 502. In some embodiments, the fluid is a high pressure liquid carbon dioxide. The pressure may be over the critical pressure of the carbon dioxide, e.g. 72.8 atm. After being provided at 502, the fluid is diverted into multiple fluid flow paths 504. In some embodiments, the number of flow paths is two, although it should be appreciated that any number of flow paths may be used. Each flow path directs the fluid to a thermal reservoir 506. In an embodiment with two flow paths, a first thermal reservoir may be configured as a low temperature thermal reservoir, and a second thermal reservoir may be configured as a high temperature thermal reservoir. At 508, the low temperature thermal reservoir heats and/or maintains the fluid at a first temperature that is at or above its critical temperature such that the fluid is in a supercritical state. The high temperature thermal reservoir may also heat and/or maintain the fluid at a second temperature greater than that of the first reservoir in a supercritical state at 508. In instances in which heaters are provided in each reservoir to control a temperature of the supercritical machining fluid, the heaters in each reservoir may be controlled using feedback from thermocouples configured to sense a temperature of the supercritical machining fluid within the reservoirs.

After providing the two or more reservoirs of supercritical machining fluids at the desired temperatures, associated flow control devices may be operated to provide a desired flow rate of supercritical machining fluid from each of the reservoirs at a desired pressure by regulating the flow rate and pressure from each reservoir at 510 and 512. The pressure and flow rate of supercritical machining fluid from each reservoir may be controlled using feedback from sensed temperatures and/or flow rates of each flow path at 514. In some embodiments, one or more temperature sensors may be used to measure the temperature of the supercritical machining fluid flowing from each thermal reservoir at 514 which may be used to control a temperature of the supercritical machining fluid within each reservoir. In either case, the separate flows of supercritical machining fluid may then be combined at 516.

In some instances, it may be desirable to add a lubricant (e.g. an oil, a minimum quantity lubrication (MQL) fluid, or a synthetic fluid) or other machining fluid to the supercritical machining fluid before applying the supercritical fluid to a machining interface. In such embodiments, a lubricant may be added at 518 after the individual flow paths are recombined. However, instances in which the lubricant is added upstream from the point where the separate flow paths are recombined are also contemplated. The lubricant may also be heated or pressurized as needed.

At 522, a temperature of the combined flows of supercritical machining fluid may be measured. This temperature may be used to adjust the flow rate of the individual fluid paths by adjusting the associated flow control device of each path. Again by adjusting the flow rate of the high and low temperature supercritical machining fluids, it is possible to accurately and quickly control a temperature of the combined flow of supercritical machining fluid. Finally, the combined flow of supercritical machining fluid may be output from a system, which in some cases may correspond to the supercritical machining fluid being applied to a cutting interface at 522.

### Example: Tool Life Versus Supercritical Machining Fluid Temperature

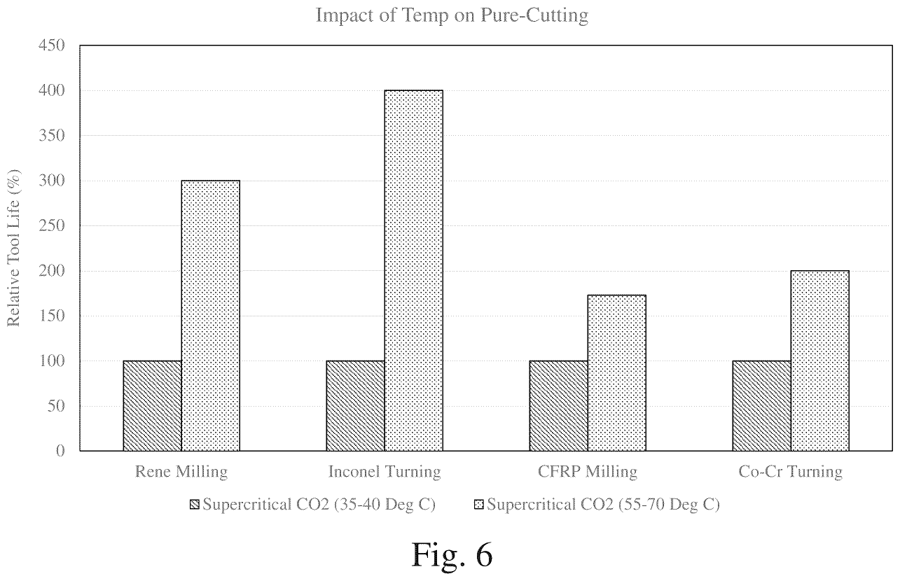

FIG. 6 shows experimental data of tool life for different machining operations and materials conducted using supercritical carbon dioxide (scCO₂) at different temperatures. In this experiment, four materials including a high temperature nickel alloy (René), an austenitic nickel chromium alloy (Inconel), a polymer composite (a carbon fiber reinforced polymer), and a cobalt-chromium alloy (Co—Cr)) were machined (milled or turned) on a machine tool while using scCO₂ as a machining fluid. During the first machining operation, each composite was machined with scCO₂ at temperatures between 35-40° C. During the second machining operation, the process was repeated with scCO₂ at temperatures between 55° C. and 60° C. Specifically, the René milling was done with scCO₂ at a temperatures of 35° C. and 55° C. and a pressure of 1500 PSI. The Inconel Turning was done with scCO₂ at temperatures of 35° C. and 60° C. with a pressure of 1700 PSI. Carbon fiber reinforced polymer milling was done with scCO₂ at temperatures of 33° C. and 60° C. with a pressure of 2000 PSI. The Co-Cr turning was conducted with scCO₂ at temperatures of 35° C. and 60° C. and a pressure of 1750 PSI. The coolant was delivered externally to the tool through the tool holder with oil flow rates mixed with the scCO₂ between about 0.75 and 1.25 mL/min for the tests.

As shown in the graph, increasing the temperature of the scCO₂ resulted in tool life improvements across all of the tested materials. In some instances, such as the Inconel turning process, an approximate 400% increase in tool life was observed. From this outcome the inventors anticipate that further improvements may be achievable with scCO₂ heated above the maximum 60° C. tested.

As noted above, in some embodiments, the systems described herein may include one or more controllers configured to operate various aspects of the machining systems, such operation of one or more valves operatively coupled to one or more pressure sensors, and/or temperature sensors. Such embodiments described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computer but with suitable processing capabilities, such as a smart phone or any other suitable portable or fixed electronic device.

Also, a computing device may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a processor readable storage medium (or multiple processor readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a processor readable storage medium may retain information for a sufficient time to provide computer-executable instructions in a non-transitory form. Such a processor readable storage medium or media can be transportable, such that the program or programs stored thereon can be loaded onto one or more different computers or other processors to implement various aspects of the present disclosure as discussed above. As used herein, the term “processor-readable storage medium” encompasses only a non-transitory processor-readable medium that can be considered to be a manufacture (i.e., article of manufacture) or a machine. Alternatively or additionally, the disclosure may be embodied as a processor readable medium other than a processor-readable storage medium, such as a propagating signal.

The terms “program” or “software” are used herein in a generic sense to refer to any type of computer code or set of processor-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Processor-executable instructions may be in many forms, such as program modules, executed by one or more processor or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in processor-readable media in any suitable form. For simplicity of illustration, data structures may be shown to have fields that are related through location in the data structure. Such relationships may likewise be achieved by assigning storage for the fields with locations in a processor-readable medium that conveys relationship between the fields. However, any suitable mechanism may be used to establish a relationship between information in fields of a data structure, including through the use of pointers, tags or other mechanisms that establish relationship between data elements.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A machining system utilizing a supercritical machining fluid, the machining system comprising:
a machine tool;
a first machining fluid supply constructed and arranged to deliver a first supercritical machining fluid to a cutting interface of the machine tool; and
a heater configured to heat the first supercritical machining fluid to a predetermined temperature at least 20° C. greater than a critical temperature of the supercritical machining fluid.

2. The machining system of claim 1, wherein the predetermined temperature is between or equal to 50° C. and 120° C..

3. The machining system of claim 2, wherein the predetermined temperature is between or equal to 55° C. and 80° C.

4. The machining system of claim 1, wherein the first supercritical machining fluid comprises supercritical carbon dioxide.

5. The machining system of claim 1, wherein the heater comprises at least one selected from the group of an electric vaporizer, a thermoelectric Peltier heater, and an electric resistance heater.

6. The machining system of claim 1, further comprising a second machining fluid mixed with the first supercritical machining fluid.

7. The machining system of claim 6, wherein the second machining fluid is a second supercritical machining fluid different from the first supercritical machining fluid.

8. The machining system of claim 6, wherein the second machining fluid is a non-supercritical machining fluid.

9. The machining system of claim 1, further comprising a temperature sensor configured to sense a temperature of the supercritical machining fluid.

10. The machining system of claim 9, further comprising a processor operatively connected to the temperature sensor and the heater, wherein the processor is configured to control the heater based on the sensed temperature to heat the first supercritical machining fluid to the predetermined temperature.

11. The machining system of claim 1, further comprising a storage tank configured to receive the first supercritical machining fluid and maintain the first supercritical machining fluid at a pressure greater than a critical pressure of the first supercritical machining fluid and a temperature greater than the critical temperature of the first supercritical machining fluid.

12. The machining system of claim 11, wherein the heater is disposed downstream from the storage tank.

13. The machining system of claim 11, wherein the heater is configured to heat the first supercritical fluid within the storage tank.

14. The machining system of claim 1, wherein the heater and the first machining fluid supply are configured to deliver the first supercritical machining fluid to a fluid expansion location at the predetermined temperature.

15. A method of machining a workpiece using a machining system utilizing a supercritical machining fluid, the method comprising:
supplying a first supercritical machining fluid to a machining system;
heating the first supercritical machining fluid to a predetermined temperature at least 20° C. greater than a critical temperature of the first supercritical machining fluid; and
delivering the first supercritical machining fluid to a cutting interface between a machining tool and a workpiece.

16. The method of claim 15, wherein the workpiece comprises at least one selected from the group of a polymer composite; a carbon fiber reinforced polymer composite; a nickel based alloy; a nickel based superalloy; and a cobalt chrome alloy.

17. The method of claim 15, wherein the predetermined temperature is between or equal to 50° C. and 120° C..

18. The method of claim 17, wherein the predetermined temperature is between or equal to 55° C. and 80° C.

19. The method of claim 15, further comprising mixing a second machining fluid with the first supercritical machining fluid.

20. The method of claim 19, wherein the second machining fluid is a second supercritical machining fluid different from the first supercritical machining fluid.

21. The method of claim 19, wherein the second machining fluid is a non-supercritical machining fluid.

22. The method of claim 15, wherein the supercritical machining fluid comprises supercritical carbon dioxide.

23. The method of claim 15, delivering the first supercritical machining fluid to a fluid expansion location at the predetermined temperature.

24. A system for providing a supercritical machining fluid, the system comprising:
a first low temperature reservoir configured to contain a first supercritical machining fluid at a first temperature;
a second high temperature reservoir configured to contain a second supercritical machining fluid at a second temperature greater than the first temperature;
an outlet of the system;
a first flow control device configured to control a first flow of the first supercritical machining fluid to the outlet; and
a second flow control device configured to control a second flow of the second supercritical machining fluid to the outlet.

25-31. (canceled)

32. A method of machining a workpiece using a machining system utilizing a supercritical machining fluid, the method comprising
mixing a first flow of a first supercritical machining fluid at a first temperature with a second flow of a second supercritical machining fluid at a second temperature different from the first temperature to provide a combined flow of supercritical machining fluid at a third temperature between the first and second temperatures; and
applying the combined flow of supercritical machining fluid to a cutting interface.

32-38. (canceled)
